(19) United States
(12) Patent Application Publication
(10) Pub. No.: US 2012/0096465 A1
(43) Pub. Date: Apr. 19, 2012

(54) IMAGE FORMING APPARATUS, LOG MANAGEMENT METHOD, AND STORAGE MEDIUM

(75) Inventor: Daisuke KAMISHIRO, Kanagawa (JP)

(73) Assignee: RICOH COMPANY, LTD.

(21) Appl. No.: 13/238,108

(22) Filed: Sep. 21, 2011

(30) Foreign Application Priority Data
Oct. 18, 2010 (JP) 2010-233716

(51) Int. Cl. G06F 9/46

(52) U.S. Cl. 718/100

(57) ABSTRACT

An image forming apparatus includes application programs that generate logs, an interface information storing unit configured to store interface information for the respective application programs, and a log management unit. The interface information is used to obtain the logs generated by the corresponding application programs. The log management unit is configured to receive a log acquisition request, to obtain the logs of one or more of the application programs specified in the log acquisition request based on the corresponding interface information stored in the interface information storing unit, and to output the obtained logs as a response to the log acquisition request.

### CROSS-REFERENCE TO RELATED APPLICATION

The present application is based upon and claims the benefit of priority of Japanese Patent Application No. 2010-233716, filed on Oct. 18, 2010, the entire contents of which are incorporated herein by reference.

### BACKGROUND OF THE INVENTION

1. Field of the Invention

An aspect of this disclosure relates to an image forming apparatus, a log management method, and a storage medium.

2. Description of the Related Art

Like general-purpose computers, present-day image forming apparatuses such as a copier, a printer, a facsimile machine, and a multifunction peripheral have a configuration that allows installation of additional application programs. Generally, such application programs are configured to output logs that are used, for example, for fault analysis and/or accounting.

As the number of application programs installed in an image forming apparatus increases, the frequency of using the logs of the application programs by, for example, a service person may also increase. For this reason, a method or a mechanism for efficiently handling and managing logs of application programs is desired.

For example, Japanese Laid-Open Patent Publication No. 10-055294 discloses a method for centrally or collectively managing logs of multiple programs running on a computer. In the disclosed method, logs of multiple programs are stored in one log file using an exclusive access control mechanism.

With the disclosed method, however, to view a log of a specific application program, it is necessary to retrieve the log from the log file containing logs of multiple application programs.

### SUMMARY OF THE INVENTION

In an aspect of this disclosure, there is provided an image forming apparatus including application programs that generate logs, an interface information storing unit configured to store interface information for the respective application programs, and a log management unit. The interface information is used to obtain the logs generated by the corresponding application programs. The log management unit is configured to receive a log acquisition request, to obtain the logs of one or more of the application programs specified in the log acquisition request based on the corresponding interface information stored in the interface information storing unit, and to output the obtained logs as a response to the log acquisition request.

### BRIEF DESCRIPTION OF THE DRAWINGS

FIG. 1 is a drawing illustrating an exemplary configuration of a system according to an embodiment;

FIG. 2 is a block diagram illustrating an exemplary hardware configuration of an image forming apparatus;

FIG. 3 is a drawing illustrating an exemplary software configuration of an image forming apparatus;

FIG. 4 is a table illustrating an exemplary data structure of an installed application information storing unit;

FIG. 5 is a sequence chart illustrating an exemplary process of generating logs;

FIG. 6 is a table illustrating an exemplary data structure of an application log format storing unit;

FIG. 7 is a table illustrating an exemplary data structure of a log format information storing unit;

FIG. 8 is a drawing illustrating an exemplary log generated based on a log format;

FIG. 9 is a drawing illustrating another exemplary log generated based on a log format;

FIG. 10 is a drawing illustrating an exemplary log generated by merging multiple logs having different log IDs;

FIG. 11 is a drawing illustrating another exemplary log generated by merging multiple logs having different log IDs;

FIG. 12 is a drawing illustrating an exemplary log generated without using a log format;

FIG. 13 is a drawing illustrating another exemplary log generated without using a log format;

FIG. 14 is a sequence chart illustrating an exemplary process of viewing a log;

FIG. 15 is a table illustrating an exemplary data structure of an authentication information storing unit;

FIG. 16 is a table illustrating an exemplary data structure of an application login information storing unit;

FIG. 17 is a table illustrating an exemplary data structure of a log access right information storing unit;

FIG. 18 is a table illustrating an exemplary data structure of a log ID information storing unit; and

FIG. 19 is a table illustrating an exemplary data structure of a log I/F information storing unit.

### DESCRIPTION OF THE PREFERRED EMBODIMENTS

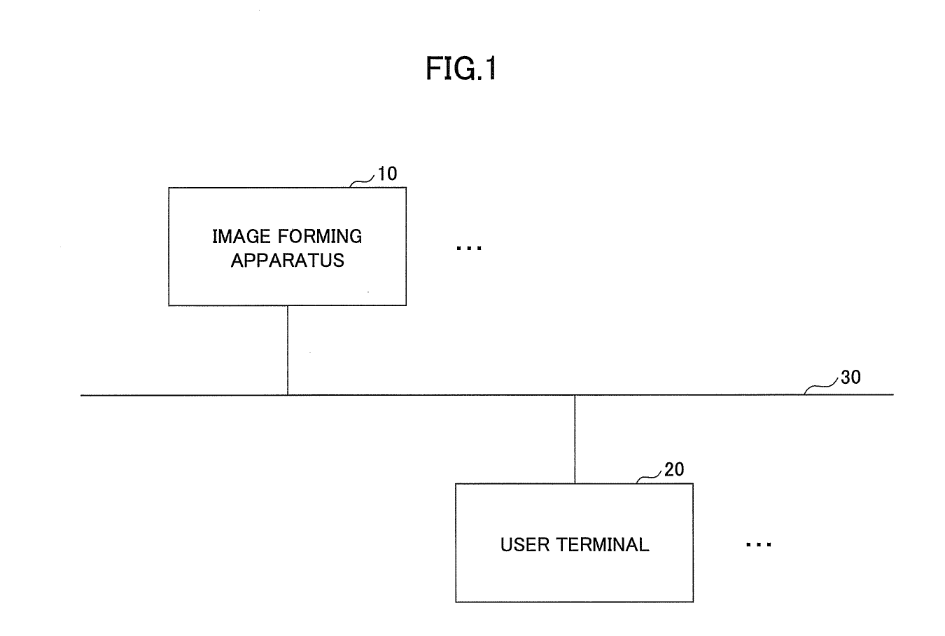

Preferred embodiments of the present invention are described below with reference to the accompanying drawings. FIG. 1 is a drawing illustrating an exemplary configuration of a system according to an embodiment. As illustrated in FIG. 1, the system includes at least one image forming apparatus 10 and at least one user terminal 20 that are connected via a (wired or wireless) network 30 such as a local area network (LAN) for communications.

The image forming apparatus 10 may be, for example, a multifunction peripheral including two or more of functions such as printing, scanning, copying, and facsimile transmission and reception. Alternatively, the image forming apparatus 10 may be an apparatus that provides any one of such functions. Programs can be installed into and uninstalled from the image forming apparatus 10 to add and remove functions.

The user terminal 20 may be implemented, for example, by a personal computer (PC) including an input unit such as a mouse and a keyboard and a display unit such as a liquid-crystal display. The user terminal 20 functions as a remote user interface for the image forming apparatus 10. Alternatively, the user terminal 20 may be implemented by a portable communication terminal such as a cell phone, a smartphone, or a personal digital assistant (PDA).

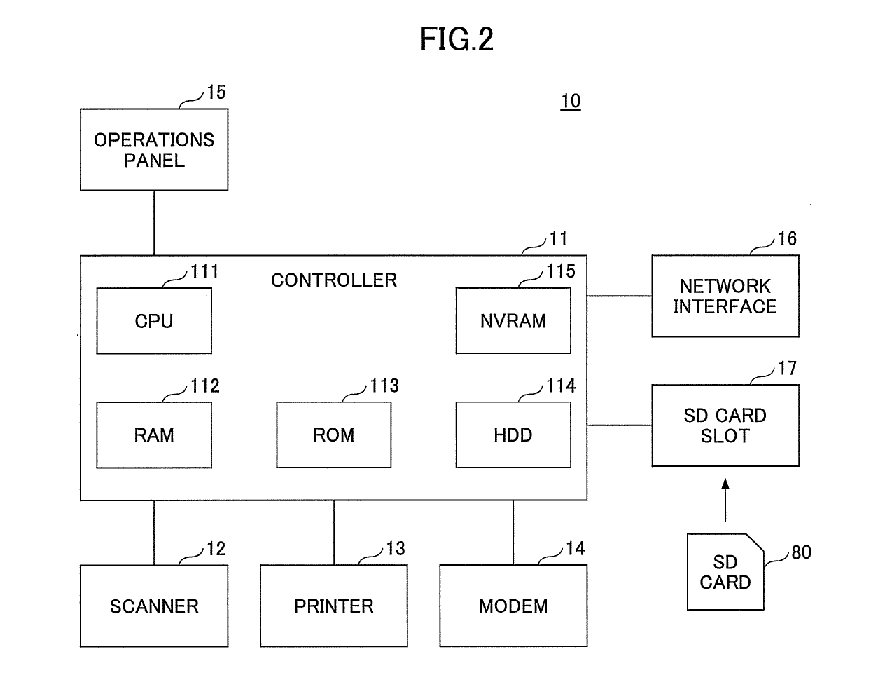

FIG. 2 is a block diagram illustrating an exemplary hardware configuration of the image forming apparatus 10. As illustrated in FIG. 2, the image forming apparatus 10 may include, as hardware components, a controller 11, a scanner 12, a printer 13, a modem 14, an operations panel 15, a network interface 16, and a secure digital (SD) card slot 17.

The controller 11 may include a CPU 111, a RAM 112, a ROM 113, an HDD 114, and a non-volatile RAM (NVRAM) 115. The ROM 113 stores, for example, programs and data used by the programs. The RAM 112 is used, for example, as a storage area into which programs are loaded and as a work area for the loaded programs. The CPU 111 executes the programs loaded into the RAM 112 to implement various functions. The HDD 114 stores, for example, programs and data used by the programs. The NVRAM 115 stores, for example, various settings.

The scanner 12 is a hardware component (image scanning unit) for scanning a document to obtain image data. The printer 13 is a hardware component (printing unit) for printing print data on a recording medium such as paper. The modem 14 is a hardware component for connecting the image forming apparatus 10 to a telephone line and is used to send and receive image data for facsimile communications. The operations panel 15 is a hardware component including an input unit such as buttons for receiving user inputs and a display unit such as a liquid crystal display panel. The network interface is a hardware component for connecting the image forming apparatus 10 to a (wired or wireless) network such as a LAN. The SD card slot 17 reads, for example, programs stored in an SD card 80. With the image forming apparatus 10 of this embodiment, in addition to the programs stored in the ROM 113, programs stored in the SD card 80 can be loaded into the RAM 112 and executed. Instead of the SD card 80, any other storage medium (e.g., a CD-ROM or a universal serial bus (USB) memory) may also be used for this purpose. That is, a storage medium that can be mounted on the image forming apparatus is not limited to the SD card 80. When a storage medium other than the SD card 80 is used, the SD card slot 17 may be replaced with a hardware component corresponding to the storage medium used.

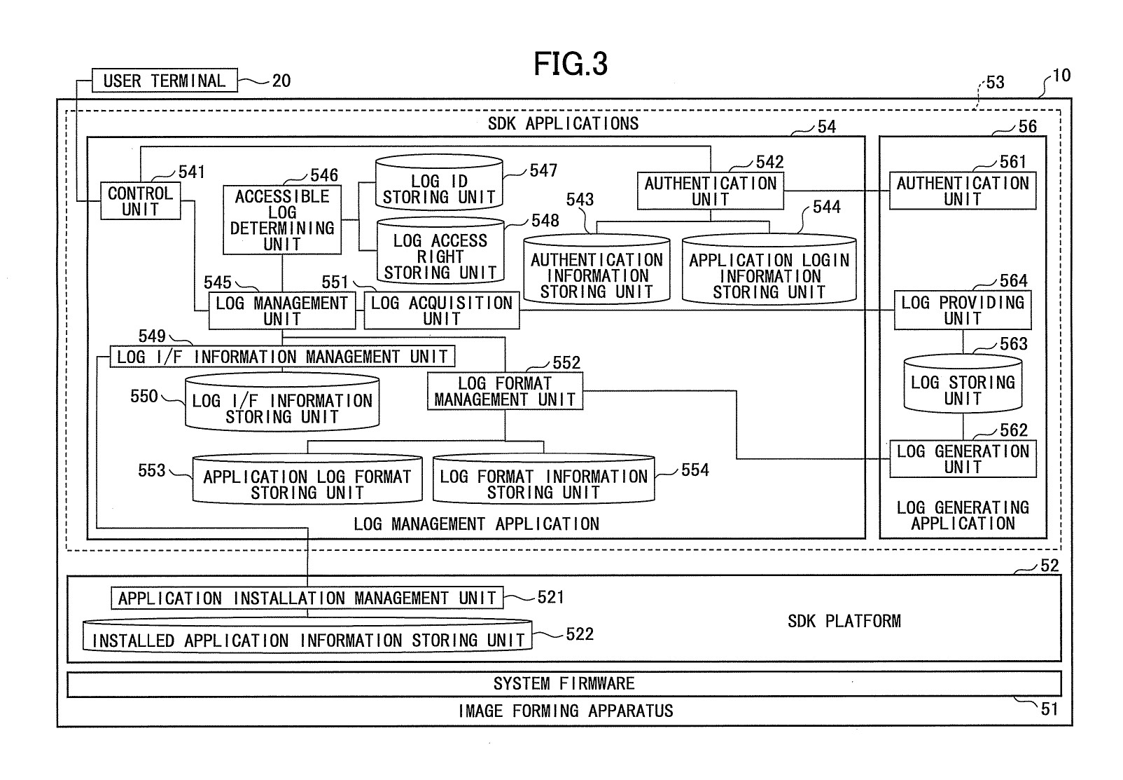

FIG. 3 is a drawing illustrating an exemplary software configuration of the image forming apparatus 10. The image forming apparatus 10 includes system firmware 51, an SDK platform 52, and one or more SDK applications 53.

The system firmware 51 is implemented by software modules that provide upper-layer applications with functions for controlling various hardware resources. For example, the system firmware 51 provides a network communication function, a scanner control function, a printer control function, and a memory management function.

The SDK platform 52 provides an execution environment for the SDK applications 53. The SDK applications 53 are developed using application programming interfaces (API) provided by the SDK platform 52. For example, the SDK platform 52 provides the SDK applications 53 with a scanning function interface, a print function interface, and a copy function interface. APIs provided by the SDK platform 52 may be made public to allow a third party to develop the SDK applications 53. In this embodiment, it is assumed that the SDK platform 52 includes a Java (registered trademark) virtual machine and the SDK applications 53 are implemented as Java (registered trademark) applications. However, this embodiment may also be applied to applications written in any other programming language.

The SDK platform 52 also manages life cycles of the SDK applications 53. The SDK platform 52 includes an application installation management unit 521 and an installed application information storing unit 522.

The application installation management unit 521 installs and uninstalls the SDK applications 53. A request to install or uninstall an SDK application 53 may be input via the operations panel 15 or the user terminal 20.

The installed application information storing unit 522 stores a list of installed SDK applications 53, and may be implemented, for example, by a storage area of the NVRAM 115 or the HDD 114.

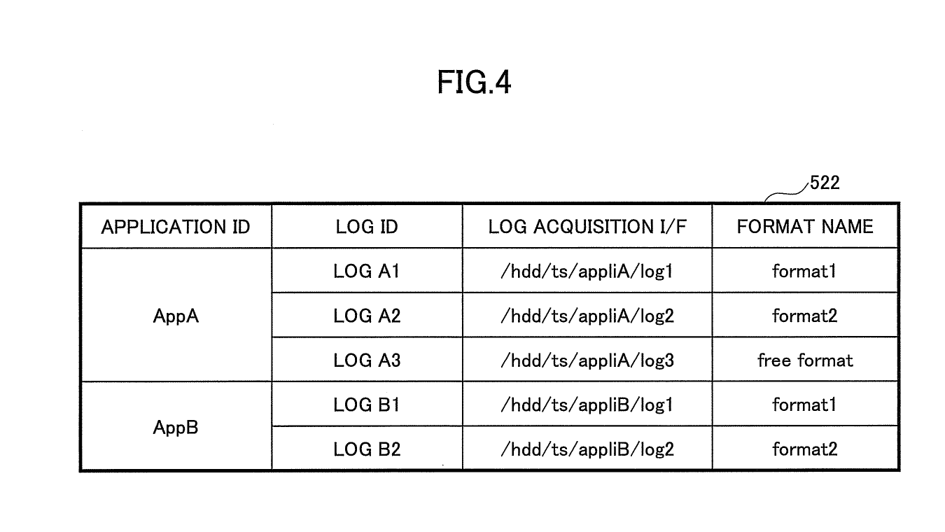

FIG. 4 is a table illustrating an exemplary data structure of the installed application information storing unit 522. As illustrated in FIG. 4, the installed application information storing unit 522 stores application IDs for the respective SDK applications 53 installed in the image forming apparatus 10. The application IDs are identifiers of the respective SDK applications 53. The installed application information storing unit 522 also stores log IDs of logs generated by the SDK applications 53, and a log acquisition I/F and a format name for each of the log IDs. One or more log IDs may be assigned to each of the SDK applications 53 that generates logs (hereafter may be called log generating applications 56). The log IDs may correspond to the categories (or types) of internal functions of the log generating application 56. For example, different log IDs may be assigned to a log for a display function and a log for an image forming function of the log generating application 56. Alternatively, a log ID may be assigned to each log file that may include one or more types of logs. Thus, logs may be grouped into categories based on any appropriate criterion and log IDs may be assigned to the respective categories.

The log acquisition I/F is interface information or identification information used to obtain a log associated with the corresponding log ID. In the example of FIG. 4, a file path name indicating the location where a log is stored is used as the log acquisition I/F. Alternatively, any other type of information such as a function identifier or a uniform resource identifier (URI) may be used as the log acquisition I/F. The format name indicates log format information (information on the format or configuration of a log) of a log associated with the corresponding log ID.

When an SDK application 53 is installed, the application installation management unit 521 adds a record for the installed SDK application 53 in the installed application information storing unit 522. For example, each SDK application 53 may be accompanied by a file containing attribute information of the SDK application 53. The application installation management unit 521 records information extracted from the file in the installed application information storing unit 522. Meanwhile, when an SDK application 53 is uninstalled, the application installation management unit 521 deletes the record of the uninstalled SDK application 53 from the installed application information storing unit 522.

The SDK applications 53 are plug-in applications that are additionally installed in the image forming apparatus 10 after its factory shipment to expand the functions of the image forming apparatus 10. In the example of FIG. 4, the image forming apparatus 10 includes a log management application 54 and one or more log generating applications 56 as the SDK applications 53. The log management application 54 centrally or solely controls operations on logs generated or recorded by the log generating applications 56.

Here, the term “log generating application” is used in contrast to the term “log management application”. Each of the log generating applications 56 is an SDK application 53 that has a unique function and generates a log in the process of performing the unique function. Accordingly, generating a log is not the primary function of the log generating application 56. In this embodiment, the SDK applications 53 other than the log management application 54 are the log generating applications 56.

The log generating application 56 may include an authentication unit 561, a log generation unit 562, a log storing unit 563, and a log providing unit 564. The authentication unit 561 authenticates users of the log generating application 56. The log generation unit 562 generates a log(s) of the log generating application 56. The log storing unit 563 stores the log generated by the log generation unit 562 and may be implemented, for example, by a storage area of the NVRAM 115 or the HDD 114. The log providing unit 564 communicates with the log management application 54 and provides (or sends) a log stored in the log storing unit 563 to the log management application 54.

The log management application 54 includes a control unit 541, an authentication unit 542, an authentication information storing unit 543, an application login information storing unit 544, a log management unit 545, an accessible log determining unit 546, a log ID storing unit 547, a log access right storing unit 548, a log I/F information management unit 549, a log I/F information storing unit 550, a log acquisition unit 551, a log format management unit 552, an application log format storing unit 553, and a log format information storing unit 554.

The control unit 541 executes a process according to a request from the user terminal 20. Also, the control unit 541 sends a result of the process to the user terminal 20.

The authentication unit 542 authenticates users of the log management application 54. The authentication information storing unit 543 stores authentication information of users and may be implemented, for example, by a storage area of the NVRAM 115 or the HDD 114. The application login information storing unit 544 stores information used by the log management application 54 to log in other SDK applications 53 (i.e., the log generating applications 56) and may be implemented, for example, by a storage area of the NVRAM 115 or the HDD 114.

The log management unit 545 controls operations on logs. The accessible log determining unit 546 determines accessible logs that a user can access based on information in the log ID storing unit 547 and the log access right storing unit 548. For example, the accessible log determining unit 546 determines accessible logs in the units of log IDs.

The log ID storing unit 547 stores information indicating the correspondence between the log generating applications 56 and the log IDs, and may be implemented, for example, by a storage area of the NVRAM 115 or the HDD 114. The log access right storing unit 548 stores information indicating the correspondence between log access rights and log IDs of logs accessible with the log access rights, and may be implemented, for example, by a storage area of the NVRAM 115 or the HDD 114. The log access rights indicate rights to access logs. For each log access right, one or more log IDs of logs accessible with the log access right are listed.

The log I/F information management unit 549 provides access to the log I/F information storing unit 550. The log I/F information storing unit 550 stores, for each log ID, identification information (log I/F information) used to obtain a log associated with the log ID, and may be implemented, for example, by a storage area of the NVRAM 115 or the HDD 114. The log acquisition unit 551 obtains logs generated by the log generating applications 56 using the log I/F information.

The log format management unit 552 provides access to the application log format storing unit 553 and the log format information storing unit 554. The application log format storing unit 553 stores identification information (format names) of log formats in association with the log IDs, and may be implemented, for example, by a storage area of the NVRAM 115 or the HDD 114. The log format information storing unit 554 stores log format information in association with the format names, and may be implemented, for example, by a storage area of the NVRAM 115 or the HDD 114. The log format information defines the log formats.

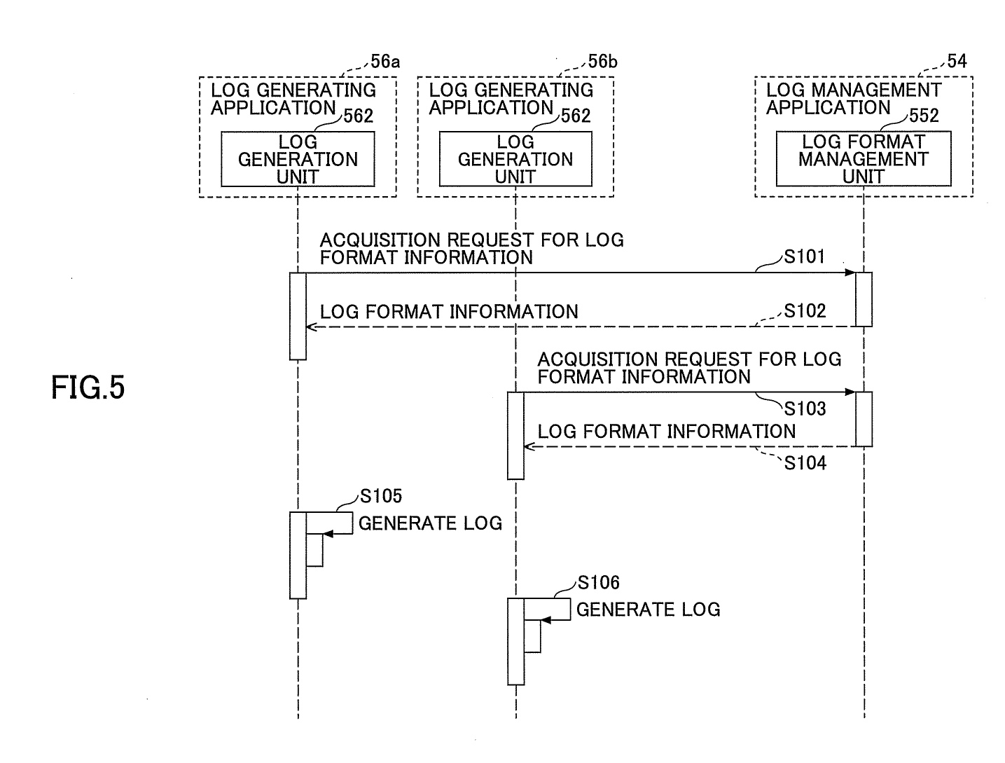

An exemplary process performed by the image forming apparatus 10 is described below. FIG. 5 is a sequence chart illustrating an exemplary process of generating logs.

In FIG. 5, the log generation unit 562 of the log generating application 56 (56a or 56b), during a startup process of the log generating application 56, sends an acquisition request for log format information to the log format management unit 552 of the log management application 54 (S101, S103). The acquisition request includes one or more log IDs of logs to be generated by the log generating application 56.

When receiving the acquisition request, the log format management unit 552 determines log format information corresponding to the log IDs specified in the acquisition request based on the information stored in the application log format storing unit 553 and the log format information storing unit 554. More specifically, the log format management unit 552 obtains format names corresponding to the log IDs specified in the acquisition request from the application log format storing unit 553.

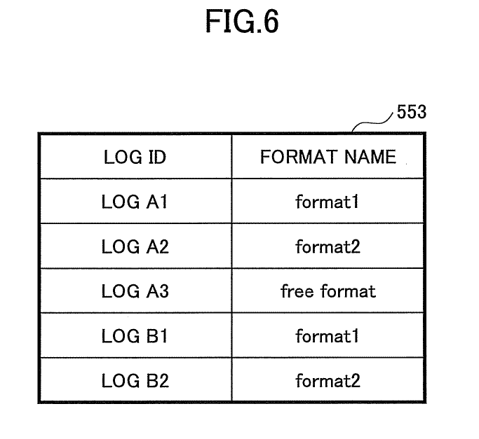

FIG. 6 is a table illustrating an exemplary data structure of the application log format storing unit 553. As illustrated in FIG. 6, the application log format storing unit 553 stores format names in association with the log IDs. Multiple logs may have the same log format, and therefore the same format name may be associated with multiple log IDs.

Records in the application log format storing unit 553 may be generated by extracting log IDs and format names from the records in the installed application information storing unit 522. For example, when an SDK application 53 is installed, the log format management unit 552 of the log management application 54 extracts log IDs and format names from the record of the installed SDK application 53 in the installed application information storing unit 522, and registers a record including the extracted log IDs and format names in the application log format storing unit 553. Meanwhile, when an SDK application 53 is uninstalled, the log format management unit 552 deletes the record of the uninstalled SDK application 53 from the application log format storing unit 553.

The log format management unit 552 obtains, from the log format information storing unit 554, log format information corresponding to the format names obtained from the application log format storing unit 553.

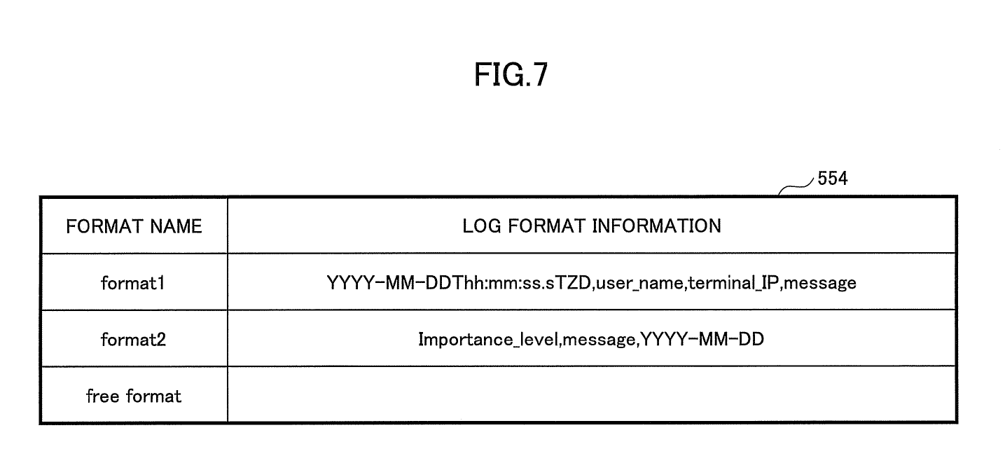

FIG. 7 is a table illustrating an exemplary data structure of the log format information storing unit 554. As illustrated in FIG. 7, the log format information storing unit 554 stores log format information in association with the format names. The log format information defines, for example, the order of information items constituting one line (or record) of a log, and formats and types (or contents) of the respective information items.

Referring back to FIG. 5, the log format management unit 552 sends the log format information obtained from the log format information storing unit 554 together with the corresponding log IDs to the log generating application 56 (S102, S104). Thus, when the acquisition request includes multiple log IDs and different format names are associated with the log IDs, multiple sets of log format information are sent to the log generating application 56. The log generation unit 562 of the log generating application 56 (56a, 56b) stores the log format information in association with the log IDs in, for example, the RAM 112.

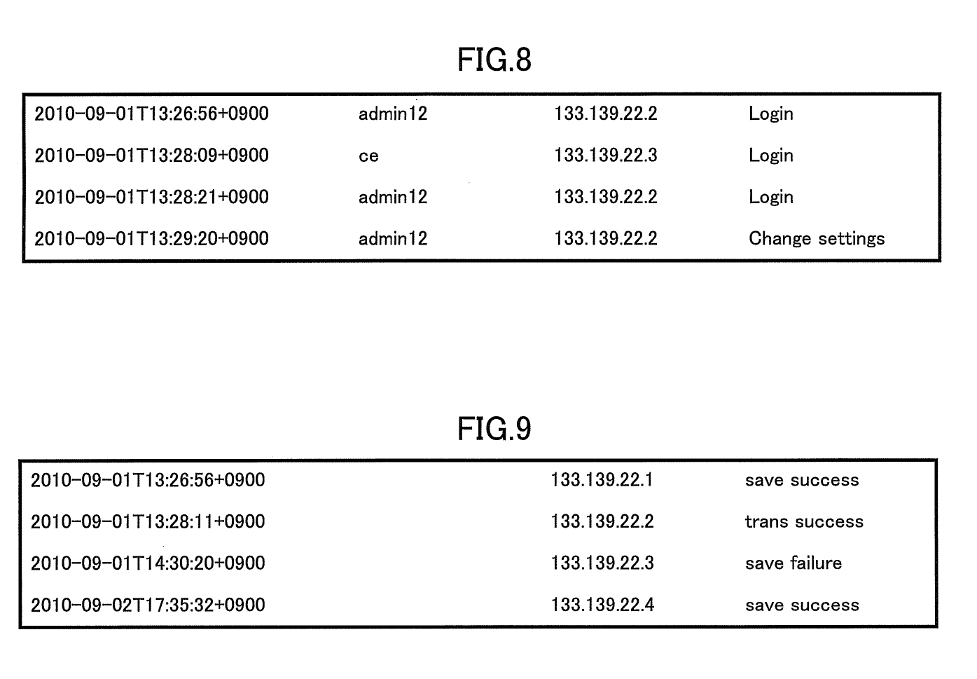

Thereafter, the log generation unit 562 of the log generating application 56 generates logs as the process performed by the log generating application 56 proceeds and stores the logs in the log storing unit 563 (S105, S106). The generated logs are stored in the log storing unit 563 such that the logs can be identified with log acquisition I/Fs corresponding to the log IDs of the logs. The log acquisition I/Fs corresponding to the log IDs may be known to the log generating application 56 or may be obtained from the installed application information storing unit 522. Logs are generated according to the log format information associated with the log IDs of the logs. Exemplary logs generated according to a log format “format1” are described below with reference to FIGS. 8 and 9.

FIG. 8 is a drawing illustrating an exemplary log generated based on a log format. FIG. 9 is a drawing illustrating another exemplary log generated based on a log format.

Here, it is assumed that the log of FIG. 8 is associated with a log ID “log A1” and the log of FIG. 9 is associated with a log ID “log B1”. The log IDs “log A1” and “log B1” are associated with the same format name (i.e., the same log format). Therefore, the logs of FIGS. 8 and 9 are generated based on the same log format. This indicates that it is possible to merge the logs of FIGS. 8 and 9 with different log IDs and display the merged log. Also, it is possible to sort the records in the merged log using a given information item as a key.

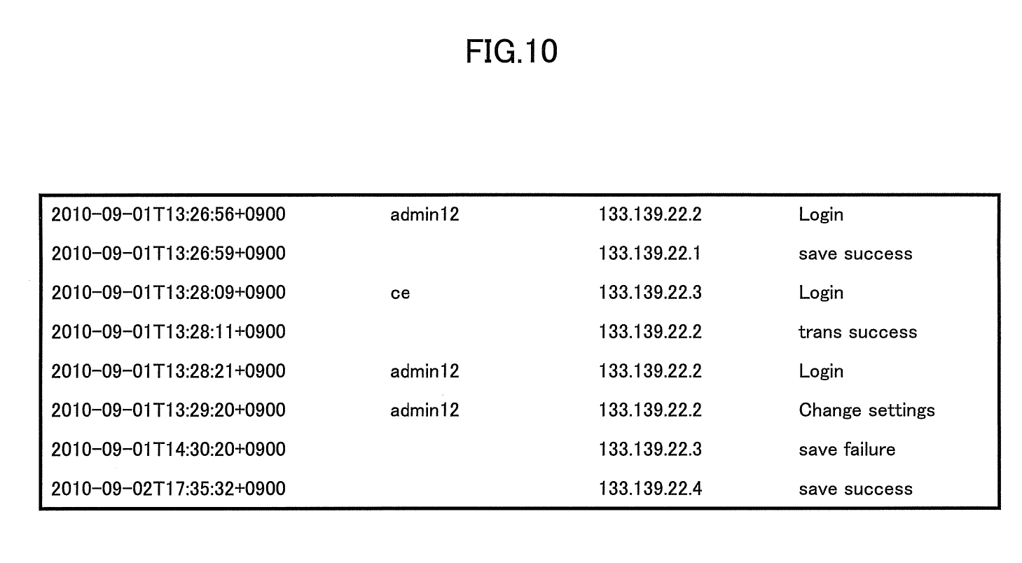

FIG. 10 is a drawing illustrating an exemplary log generated by merging multiple logs having different log IDs. The log of FIG. 10 is generated by merging the logs of FIGS. 8 and 9 and sorting the records in the log in ascending order of a first information item (date and time).

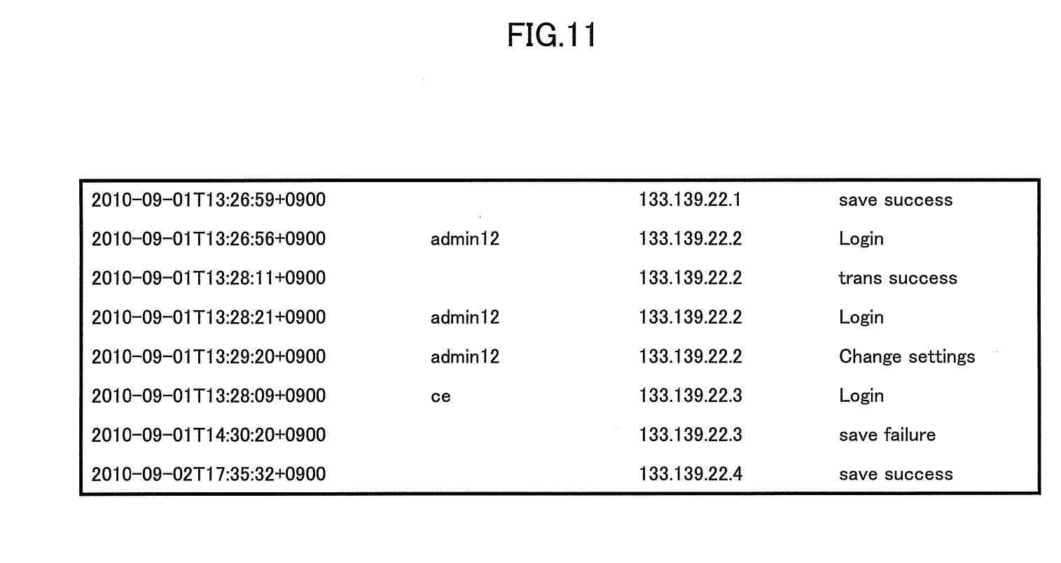

FIG. 11 is a drawing illustrating another exemplary log generated by merging multiple logs having different log IDs. The log of FIG. 11 is generated by merging the logs of FIGS. 8 and 9 and sorting the records in the log in ascending order of a third information item (terminal IP address). The terminal IP address is, for example, the IP address of the user terminal 20 that has remotely operated or used the log generating application 56 that has generated one or both of the logs of FIGS. 8 and 9.

Thus, this embodiment makes it possible to manage log formats in a unified or integrated manner, to use a common log format for different logs, and to efficiently handle logs. Also, this embodiment makes it possible to improve the readability of logs. Further, this embodiment makes it possible to manage log formats centrally or solely by the log management application 54 and thereby makes it possible to easily change log formats.

The log of FIG. 9 does not include user names of users who operated the log generating application 56. This indicates that the log generating application 56 that generated the log had been used by unauthenticated users. That is, authentication is not always necessary to use a log generating application 56. For example, use of all functions of a log generating application 56 may be allowed for unauthenticated users, and use of some or all of the functions of another log generating application 56 may be restricted to authenticated users.

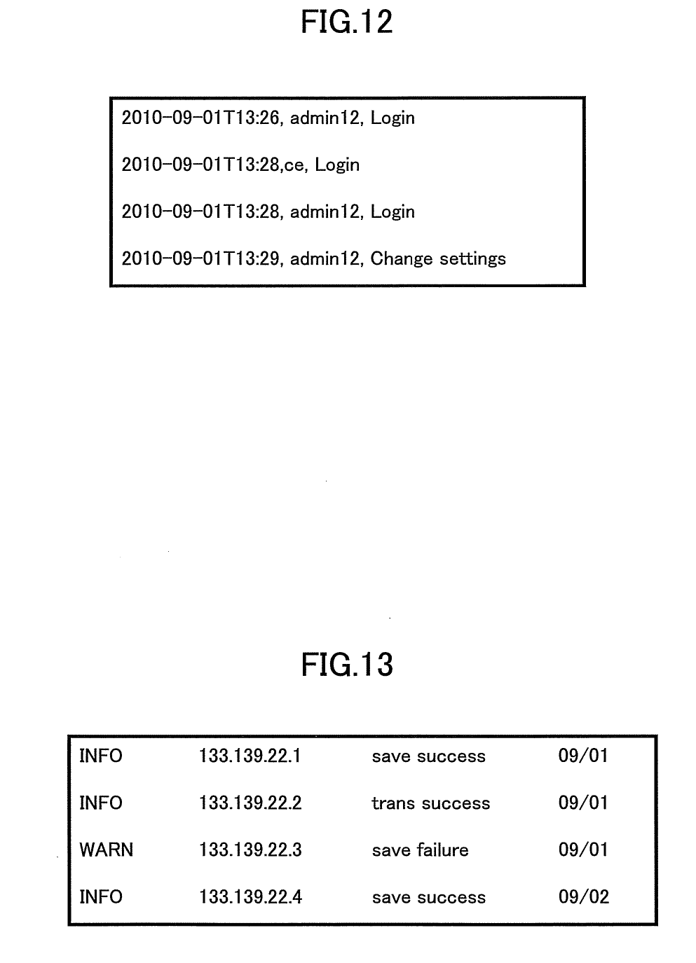

FIG. 12 is a drawing illustrating an exemplary log generated without using a log format. The log of FIG. 12 is the same as the log of FIG. 8 except that no log format is applied. FIG. 13 is a drawing illustrating another exemplary log generated without using a log format. The log of FIG. 13 is the same as the log of FIG. 9 except that no log format is applied. As is apparent from FIGS. 12 and 13, the formats of the logs of FIGS. 12 and 13 are different from each other. For example, the order of information items and the delimiter used to separate the information items in the log of FIG. 12 are different from those in the log of FIG. 13. Accordingly, it is difficult to merge the logs of FIGS. 12 and 13. Also, since the logs of FIGS. 12 and 13 have different formats, it is difficult to read the logs.

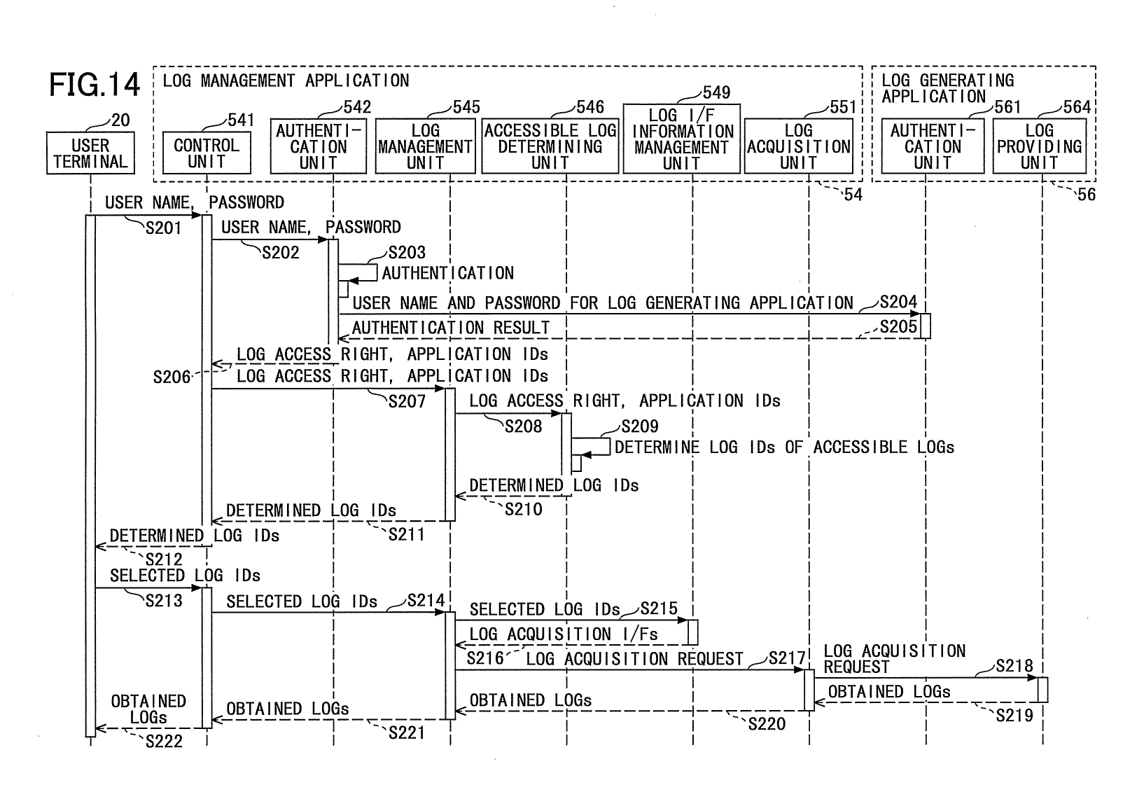

An exemplary process of viewing a log is described below with reference to the sequence chart of FIG. 14. In this exemplary process, it is assumed that a login screen of the log management application 54 is displayed on the user terminal 20. For example, the login screen is displayed when a request to use the log management application 54 is input on the user terminal 20. It is also assumed that a program for managing the image forming apparatus 10 is installed in the user terminal 20. The user terminal 20 is controlled by the program to perform a part of the process of FIG. 14. Alternatively, the part of the process of FIG. 14 may be performed by a Web browser of the user terminal 20. In other words, the image forming apparatus 10 may be configured to provide a user interface for the user terminal 20 as a Web page. In this case, it is not necessary to install the program for managing the image forming apparatus 10 in the user terminal 20.

When a user enters authentication information (a user name and a password) on the login screen displayed on the user terminal 20, the user terminal 20 sends a login request including the user name and the password to the log management application 54 of the image forming apparatus 10 (S201).

When receiving the login request, the control unit 541 of the log management application 54 requests the authentication unit 542 to perform authentication corresponding to the login request (S202). The authentication unit 542 authenticates the user by comparing the user name and the password in the login request with pairs (or records) of user names and passwords stored in the authentication information storing unit 543 (S203).

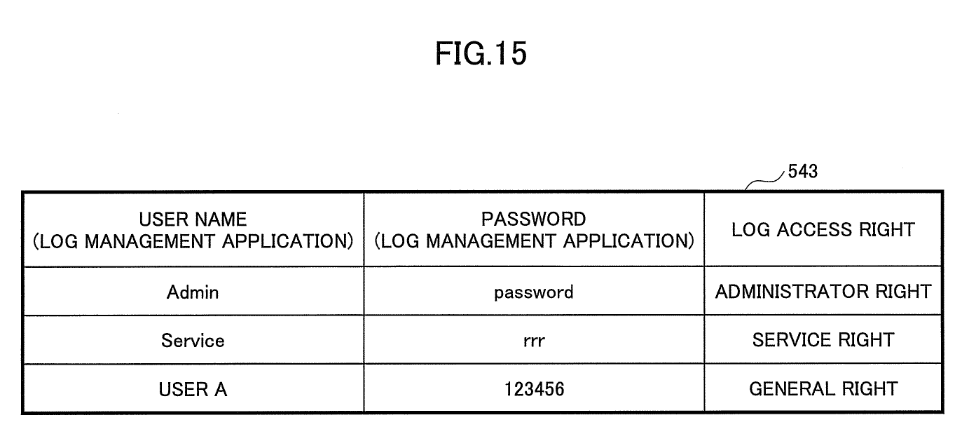

FIG. 15 is a table illustrating an exemplary data structure of the authentication information storing unit 543. As illustrated in FIG. 15, the authentication information storing unit 543 stores a user name, a password, and a log access right for each user. In this example, log access rights include an administrator right, a service right, and a general right. The administrator right is given to a system administrator whose user name is “Admin”. The service right is given to a service person of the image forming apparatus 10 whose user name is “Service”. The general right is given to general users other than the system administrator and the service person.

When a record including the same user name and password as those in the login request is found in the authentication information storing unit 543, the authentication unit 542 determines that the user is successfully authenticated, and obtains and temporarily stores the log access right included in the found record.

Next, the authentication unit 542 sends an authentication request to each of the log generating applications 56 to log into the log generating applications 56 (S204). In this embodiment, it is assumed that the log management application 54 needs to be authenticated by the log generating application 56 to obtain a log from the log generating application 56. The authentication request includes authentication information for the log generating application 56. The authentication unit 542 obtains the authentication information from the application login information storing unit 544.

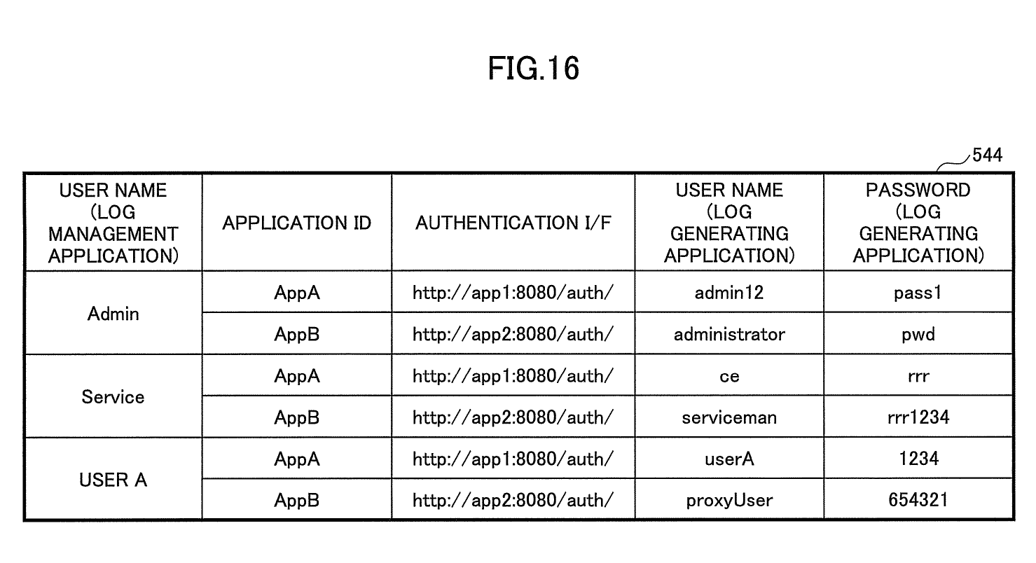

FIG. 16 is a table illustrating an exemplary data structure of the application login information storing unit 544. As illustrated in FIG. 16, the application login information storing unit 544 stores one or more application IDs of the log generating applications 56 for each user name (first user name) of the log management application 54. The application login information storing unit 544 also stores, for each of the application IDs, an authentication I/F and a user name (second user name) and a password for the corresponding log generating application 56.

The authentication I/F is interface information used to send an authentication request to the log generating application 56 with the associated application ID. In the example of FIG. 16, a uniform resource identifier (URI) is used as the authentication I/F. Alternatively, any other type of information such as a function identifier may be used as the authentication I/F. The second user name and the password are used by the log management application 54 to log into the corresponding log generating application 56 for the user identified by the first user name.

The authentication unit 542 obtains, from the application login information storing unit 544, the authentication I/F, the second user name, and the password for each of the application IDs associated with the first user name of the user (login user) who has been successfully authenticated by the log management application 54. In step S204, the authentication unit 542 sends an authentication request to each of the log generating applications 56 corresponding to the application IDs based on the authentication I/F. The authentication request includes the second user name and the password associated with the corresponding application ID.

When receiving the authentication request, the authentication unit 561 of the log generating application 56 performs authentication based on the second user name and the password specified in the authentication request and sends the authentication result to the authentication unit 542 of the log management application 54.

When receiving the authentication results from the respective log generating applications 56, the authentication unit 542 sends the temporarily stored log access right of the login user and the application IDs of log generating applications 56 that have successfully authenticated the login user (or the log management application 54) (S206).

Next, the control unit 541 sends a determination request to determine log IDs of logs that are accessible by the login user to the log management unit 545 (S207). The determination request includes, for example, the log access right of the login user and the application IDs of the log generating applications 56 that have successfully authenticated the login user. The log management unit 545 transfers the determination request to the accessible log determining unit 546 (S208).

Then, the accessible log determining unit 546 determines log IDs of logs accessible by the login user based on the information specified in the determination request and the information stored in the log access right storing unit 548 and the log ID storing unit 547 (S209). More specifically, the accessible log determining unit 546 determines accessible log IDs of logs that are allowed to be accessed with the log access right specified in the determination request by referring to the log access right storing unit 548.

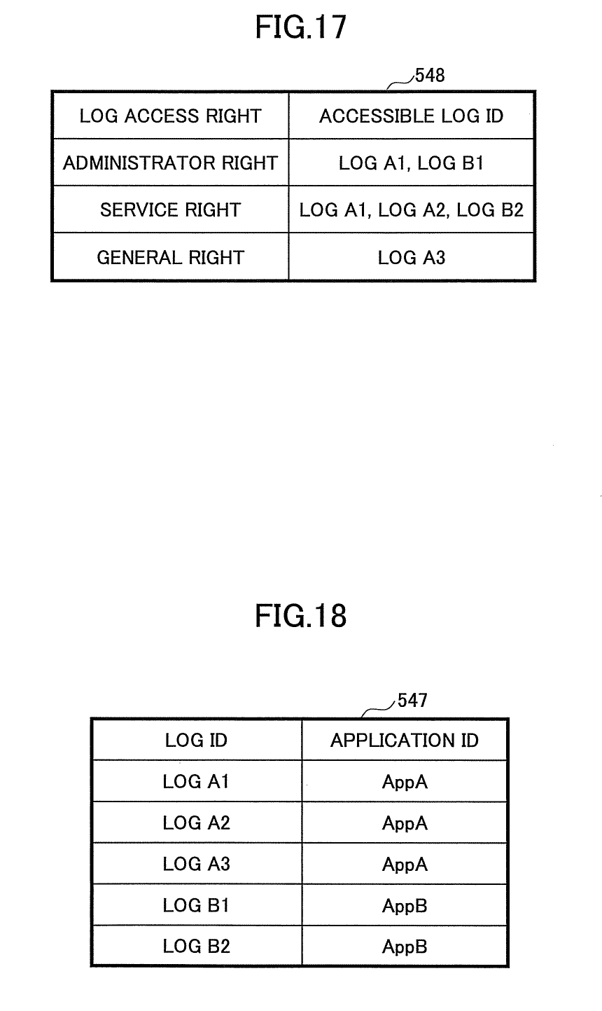

FIG. 17 is a table illustrating an exemplary data structure of the log access right storing unit 548. As illustrated in FIG. 17, the log access right storing unit 548 stores accessible log IDs in association with the log access rights. The accessible log IDs are log IDs of logs that are allowed to be accessed with the respective log access rights. For example, a user with the administrator right can access logs with log IDs “log A1” and “log B1”. Meanwhile, a user with the general right can access a log with a log ID “log A3”. The log management application 54 may be configured to allow a user (e.g., a system administrator) to edit the information stored in the log access right storing unit 548 via, for example, a screen displayed by the accessible log determining unit 546 on the operations panel 15 or the user terminal 20.

Next, the accessible log determining unit 546 extracts log IDs of logs accessible by the login user from the determined accessible log IDs based on the application IDs specified in the determination request and the information stored in the log ID storing unit 547.

FIG. 18 is a table illustrating an exemplary data structure of the log ID storing unit 547. As illustrated in FIG. 18, the log ID storing unit 547 stores, for each log ID, the application ID of the log generating application 56 that generates the log identified by the log ID.

Records in the log ID storing unit 547 may be generated by extracting log IDs and application IDs from the records in the installed application information storing unit 522. For example, when an SDK application 53 is installed, the accessible log determining unit 546 of the log management application 54 extracts log IDs and an application ID from the record of the installed SDK application 53 in the installed application information storing unit 522, and registers a record including the extracted log IDs and application ID in the log ID storing unit 547. Meanwhile, when an SDK application 53 is uninstalled, the accessible log determining unit 546 deletes the record of the uninstalled SDK application 53 from the log ID storing unit 547.

The accessible log determining unit 546 extracts log IDs associated with the application IDs specified in the determination request from the determined accessible log IDs by referring to the log ID storing unit 547. In other words, only log IDs that are associated with the application IDs of the log generating applications 56 that have successfully authenticated the login user are extracted. Take, for example, a case where a login user having the service right has been successfully authenticated by the log generating application 56 with an application ID “AppA” and has not been authenticated by the log generating application 56 with an application ID “AppB”. In this case, according to the examples of FIGS. 17 and 18, the accessible log determining unit 546 determines logs with the log IDs “log A1” and “log A2” are accessible by the login user. Here, although a user with the service right can also access a log with the log ID “log B2” (see FIG. 17), the login user who has failed to log into the log generating application 56 with the application ID “AppB” is not allowed to access a log with the log ID “log B2” associated with the application ID “AppB” (see FIG. 18).

Referring back to FIG. 14, the accessible log determining unit 546 sends the extracted log IDs of the logs accessible by the login user as the determination result to the log management unit 545 (S210). The log management unit 545 transfers the determination result to the control unit 541 (S211). The control unit 541 sends the log IDs in the determination result to the user terminal 20 (S212). Then, the user terminal 20 displays a screen (log selection screen) on a display unit to allow the user to select log IDs, i.e., logs that the user wants to view, from the extracted log IDs.

When one or more log IDs are selected by the user on the log selection screen, the user terminal 20 sends a view request (acquisition request) including the selected log IDs to the log management application 54 (S213). When receiving the view request, the control unit 541 of the log management application 54 requests the log management unit 545 to obtain logs with the log IDs in the view request (S214).

The log management unit 545 requests the log I/F information management unit 549 to obtain log acquisition I/Fs based on the log IDs (S215). The log I/F information management unit 549 obtains log acquisition I/Fs associated with the log IDs from the log I/F information storing unit 550 and sends the obtained log acquisition I/Fs to the log management unit 545 (S216).

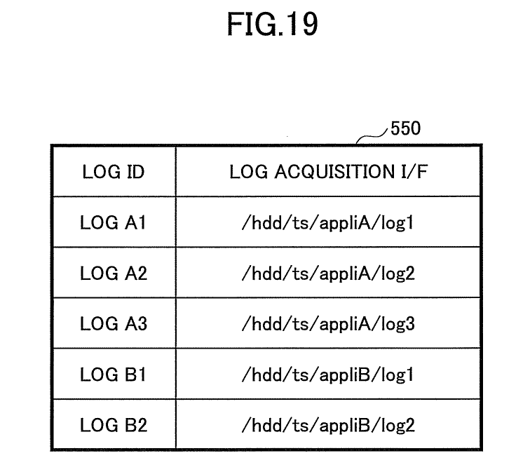

FIG. 19 is a table illustrating an exemplary data structure of the log I/F information storing unit 550. As illustrated in FIG. 19, the log I/F information storing unit 550 stores log acquisition I/Fs in association with the log IDs. In this embodiment, one or more log IDs may be assigned to one log generating application 56. Meanwhile, the same log ID is not assigned to two or more log generating applications 56. Since a log acquisition I/F is stored for each log ID, one or more log acquisition I/Fs are stored for each log generating application 56.

Records in the log I/F information storing unit 550 may be generated by extracting log IDs and log acquisition I/Fs from the records in the installed application information storing unit 522. For example, when an SDK application 53 is installed, the log I/F information management unit 549 of the log management application 54 extracts log IDs and log acquisition I/Fs from the record of the installed SDK application 53 in the installed application information storing unit 522, and registers a record including the extracted log IDs and log acquisition I/Fs in the log I/F information storing unit 550. Meanwhile, when an SDK application 53 is uninstalled, the log I/F information management unit 549 deletes the record of the uninstalled SDK application 53 from the log I/F information storing unit 550.

The log management application 54 may be configured to allow a user (e.g., a system administrator) to edit the information stored in the log I/F information storing unit 550 via, for example, a screen displayed by the log I/F information management unit 549 on the operations panel 15 or the user terminal 20.

Next, the log management unit 545 requests the log acquisition unit 551 to obtain logs based on the obtained log acquisition I/Fs (S217). For each of the log acquisition I/Fs, the log acquisition unit 551 sends an acquisition request to the log providing unit 564 of the corresponding log generating application 56 (S218). The log providing unit 564 of the log generating application 56 obtains a log corresponding to the log acquisition I/F (i.e., a log with the log ID corresponding to the log acquisition I/F) from the log storing unit 563. Then, the log providing unit 564 sends the obtained log to the log acquisition unit 551 of the log management application 54 (S219). Steps S218 and S219 are repeated for the number of log IDs selected by the user (i.e., the number of the obtained log acquisition I/Fs).

The log acquisition unit 551 sends the logs obtained through the above steps to the log management unit 545 (S220). The log management unit 545 transfers the obtained logs to the control unit 541 (S221). Then, the control unit 541 sends the obtained logs to the user terminal 20 (S222). When receiving the logs, the user terminal 20 displays the logs on a display unit to allow the user to view the logs. Thus, this embodiment enables the user to view desired logs within the access right of the user.

As described above, according to an embodiment, logs of the log generating applications 56 are managed centrally or solely by the log management application 54. For example, the log management application 54 makes it possible to centrally manage log acquisition I/Fs of the log generating applications 56 and to obtain logs of the log generating applications 56 based on the log acquisition I/Fs. Also, the log management application 54 makes it possible to obtain logs based on log IDs. Accordingly, the log management application 54 makes it easier to handle or process logs generated by multiple log generating applications 56. For example, the above embodiment enables a user (the user terminal 20) to obtain logs generated by multiple log generating applications 56 by just accessing the log management application 54, i.e., without knowing the log generating applications 56 that generated the logs.

Further, the log management application 54 makes it possible to centrally manage log access rights and thereby makes it possible to centrally control access to logs depending on the log access rights of users.

In the above embodiment, generated logs are stored in the log storing unit 363 of the corresponding log generating application 56. Alternatively, logs generated by the log generating applications 56 may be stored in a storage unit that is managed by the log management application 54. In this case, the log generating applications 56 may be configured to send generated logs to the log management application 54, or the log management application 54 may be configured to periodically obtain logs from the log generating applications 56.

In the above embodiment, one or more log IDs may be assigned to each log generating application 56. Alternatively, the image forming apparatus 10 may be configured such that only one log ID is assigned to each log generating application 56. In this case, selecting a log ID to view a log(s) equals selecting a log generating application 56 whose log(s) is to be viewed.

An aspect of this disclosure provides an image forming apparatus, a log management method, and a storage medium storing program code that make it possible to efficiently handle or manage logs generated by multiple applications.

The present invention is not limited to the specifically disclosed embodiments, and variations and modifications may be made without departing from the scope of the present invention.

What is claimed is:

1. An image forming apparatus, comprising:
application programs that generate logs;
an interface information storing unit configured to store interface information for the respective application programs, the interface information being used to obtain the logs generated by the corresponding application programs; and
a log management unit configured
to receive a log acquisition request,
to obtain the logs of one or more of the application programs specified in the log acquisition request based on the corresponding interface information stored in the interface information storing unit, and
to output the obtained logs as a response to the log acquisition request.

2. The image forming apparatus as claimed in claim 1, further comprising:
an access right information storing unit configured to store information including categories of the logs generated by the application programs and access rights of users for accessing the categories of the logs, wherein
the interface information storing unit is configured to store the interface information for each of the categories; and
the log management unit is configured
to determine the categories of the logs that are accessible by a user sending the log acquisition request based on the information stored in the access right information storing unit, and
to obtain the logs based on the interface information associated with the determined categories.

3. The image forming apparatus as claimed in claim 1, further comprising:
a log format information storing unit configured to store format information of the logs,
wherein the application programs are configured to generate the logs according to the format information stored in the log format information storing unit.

4. The image forming apparatus as claimed in claim 3, further comprising:
an application log format information storing unit configured to store information indicating a correspondence between the application programs and sets of the format information stored in the log format information storing unit,
wherein the application programs are configured to generate the logs according to the sets of the format information associated therewith in the application log format information storing unit.

5. A method of managing logs performed by an image forming apparatus including application programs that generate the logs, the method comprising:
storing interface information for the respective application programs, the interface information being used to obtain the logs generated by the corresponding application programs;
receiving a log acquisition request;
obtaining the logs of one or more of the application programs specified in the log acquisition request based on the corresponding interface information; and
outputting the obtained logs as a response to the log acquisition request.

6. The method as claimed in claim 5, further comprising:
storing access right information including categories of the logs generated by the application programs and access rights of users for accessing the categories of the logs; and
determining the categories of the logs that are accessible by a user sending the log acquisition request based on the access right information, wherein
the interface information is stored for each of the categories; and
the logs are obtained based on the interface information associated with the determined categories.

7. The method as claimed in claim 5, further comprising:
storing format information of the logs; and
generating the logs by the application programs according to the format information.

8. The method as claimed in claim 7, further comprising:
storing correspondence information indicating a correspondence between the application programs and sets of the format information,
wherein the logs are generated by the application programs according to the sets of the format information associated therewith in the correspondence information.

9. A non-transitory computer-readable storage medium storing program code for causing an image forming apparatus including application programs that generate logs to perform a method comprising:
storing interface information for the respective application programs, the interface information being used to obtain the logs generated by the corresponding application programs;
receiving a log acquisition request;
obtaining the logs of one or more of the application programs specified in the log acquisition request based on the corresponding interface information; and
outputting the obtained logs as a response to the log acquisition request.

10. The storage medium as claimed in claim 9, the method further comprising:
storing access right information including categories of the logs generated by the application programs and access rights of users for accessing the categories of the logs; and
determining the categories of the logs that are accessible by a user sending the log acquisition request based on the access right information, wherein
the interface information is stored for each of the categories; and
the logs are obtained based on the interface information associated with the determined categories.

11. The storage medium as claimed in claim 9, the method further comprising:
storing format information of the logs; and
generating the logs by the application programs according to the format information.

12. The storage medium as claimed in claim 11, the method further comprising:
storing correspondence information indicating a correspondence between the application programs and sets of the format information,
wherein the logs are generated by the application programs according to the sets of the format information associated therewith in the correspondence information.
